(19) United States
(12) Patent Application Publication
(10) Pub. No.: US 2025/0114951 A1
(43) Pub. Date: Apr. 10, 2025

(54) Mechanical coupling system and assembly comprising such a system and a gripping device

(71) Applicant: VELEC SYSTEMS, Wattrelos (FR)

(72) Inventors: Maxence MASUREL, Wattrelos (FR); Victor-Henri Chadenet, Wattrelos (FR); Florian Ghestem, Wattrelos (FR); Pierre-Louis Chatelain, Wattrelos (FR)

(21) Appl. No.: 18/910,763

(22) Filed: Oct. 9, 2024

(30) Foreign Application Priority Data
Oct. 10, 2023 (FR) 2310845

(51) Int. Cl. B25J 15/04; B25J 9/14; B25J 11/00

(52) U.S. Cl. CPC B25J 15/0408; B25J 9/144; B25J 11/0045

(57) ABSTRACT

The present disclosure relates to a mechanical coupling system comprising:
a first coupling portion comprising a first body configured to be handled by a manoeuvring system, such as a robotic arm,
a second coupling portion, comprising a second body configured to secure a gripping device
a fluidic coupling system including from at least one fluid inlet opening from the first body, and at least one channel comprising:
an inner first channel portion, extending in the mass of the first body from said at least one fluid inlet,
an inner second channel portion, extending in the mass of the second body,
the second channel portion extends, according to the length of the channel, fluidly in line with the first channel portion.

The present disclosure relates to a mechanical coupling system comprising a first coupling portion comprising a first body configured to be handled by a manoeuvring system, such as a robotic arm, and a second coupling portion, comprising a second body configured to secure a gripping device, as well as a locking system configured to switch from a locking position for which the first body and the second body are locked together, and into an unlocking position enabling the separation of the first coupling portion and of the second coupling portion.

The present disclosure also relates to an assembly comprising such a coupling system and a gripping device secured to the second body, as well as a robotic system comprising such an assembly whose first body is secured to a robotic arm.

### TECHNICAL FIELD

The present disclosure relates to the field of mechanical coupling systems, removable by separation of the first body and of the second body, and configured to enable a replacement of a gripping device at the end of a robotic arm, and more particularly in robotic systems finding a particular application in the field of automated lines where the equipment could be in contact with food products.

### PRIOR ART

In this food industry, the prior art of robotic systems in the field of automated lines knows various locking systems from the prior art of such coupling systems, facilitating for the operator the locking and unlocking operations, and thus the replacement of a gripping device.

According to the observations of the Applicant, the gripping device typically embeds one or more pneumatic actuator(s) which need to be connected by flexible hoses to a control device, connected to a compressed air source.

During maintenance operations, the operator should not only unlock the two portions of the coupling system, in order to physically separate the first body from the second body, but the removal of the gripping device also requires disconnecting the different flexible lines extending from the robotic arm up to the actuators of the gripping device, which generates a loss of time not only when dismounting, but also when mounting again when these flexible lines should be connected again.

More particularly, the present disclosure focuses on solving this problem, in the context of the food industry for which the Applicant works on obtaining equipment that is easy to clean, thereby limiting the risk of development of pathogens.

According to at least one embodiment, the present disclosure focuses on solving this problem, as well as on improving the compactness of the assembly comprising the coupling system and the gripping device, in particular according to a direction passing through an axis of the coupling system

### SUMMARY

The present disclosure improves the situation.

A mechanical coupling system is provided comprising:
a first coupling portion comprising a first body configured to be handled by a manoeuvring system, such as a robotic arm,
a second coupling portion, comprising a second body configured to secure a gripping device,
a locking system configured to switch from a locking position for which the first body and the second body are locked together, an into an unlocking position enabling the separation of the first coupling portion and of the second coupling portion.

According to the present disclosure, the coupling system is made of one or more material(s) compatible with food contact, and it includes a fluidic coupling system including from at least one fluid inlet opening from the first body, and at least one channel comprising:
an inner first channel portion, extending in the mass of the first body from said at least one fluid inlet,
an inner second channel portion, extending in the mass of the second body,
and wherein, in said locking position, the second channel portion extends, according to the length of the channel, fluidly in line with the first channel portion, a sealing means ensuring fluid tightness at the level of a junction area between the first channel portion and the second channel portion.

The features outlined in the following paragraphs can optionally be implemented independently or in combination with one another.

According to one embodiment, said at least one channel, in particular at least the first channel portion and/or the second channel portion has a curvilinear path, and in particular the curvilinear path extends according to the three dimensions of the space, said path not being contained in a plane.

According to one embodiment, the channel comprising the first channel portion and the second channel portion has no auxiliary channel, extending laterally from the first channel portion or from the second channel portion, the auxiliary channel forming a non-through dead arm including an end closed by a plug, opposite to an end opening into the first channel portion or the second channel portion.

According to one embodiment, the second channel portion extends at the opposite end of the inlet of the channel up to a fluid outlet opening from the second body.

According to one embodiment, the first coupling portion comprises a fitting connected to the fluid inlet configured for the fluidic connection of a flexible hose, and, where appropriate, a fitting connected to the fluid outlet configured for the fluidic connection of a flexible hose, extending in particular up to a pneumatic cylinder.

According to one embodiment, the second channel portion of sad at least one channel extending up to a cylinder chamber of at least one cylinder integrated into the mechanical coupling system, said cylinder chamber being obtained in the mass of said second body, said mechanical coupling system comprising a piston, internal to said cylinder chamber, configured to be moved by a compressed fluid source supplied from said inlet via said channel.

According to one embodiment, said integrated cylinder is a double-acting cylinder, the piston dividing said cylinder chamber into a first chamber and a second chamber, said at least one channel including:
a deployment control channel connected to the first chamber, comprising the first channel portion and the second channel portion opening into the first chamber, on a first side of the piston, configured to be connected to a compressed fluid source to slidably actuate the piston in a first direction,
a retraction control channel connected to the second chamber, comprising the first channel portion and the second channel portion opening into the second chamber, on a second side of the piston, configured to be connected to a compressed fluid source to slidably actuate the piston in a second direction.

According to one embodiment, the second coupling portion comprises a second body inside which the cavity-like cylinder chamber is obtained, as well as a cover portion, crossed by a rod secured to the piston, said cover portion removably fastened to the second body to enable the insertion or the extraction of the piston.

According to one embodiment, the first body and the second body are made of one or more synthetic material(s) selected among:
polyactic acid,
polypropylene,
poly (ethylene terephthalate),
polyamide, in particular polylauramide.

According to one embodiment, the external surfaces of said system, including of the first body and of the second body, are smooth; non-planar, promoting the water flow, devoid of cavities promoting the accumulation of water and microbial development, the external surfaces having a roughness Ra lower than or equal to 6 micrometres.

According to one embodiment, said locking system includes:
a clamping system comprising a first jaw and a second jaw secured to the first body configured to clasp the second body in a close position of the jaws, and to enable uncoupling in a spaced position of the jaws or alternatively,
a clamping mechanism including one or more clamping screw(s), crossing the first body, screwing threaded bores of the second body, or vice versa, preferably blind bores.

According to one embodiment, said locking system includes one or more toggle mechanism(s), the or each toggle mechanism including a first connecting rod pivotably hinged according to a first axis to the first body, a second connecting rod pivotably hinged on the first connecting rod according to a second axis, and a hooking portion secured to the second body, a hooking portion on which a portion of the second connecting rod can be pivotably hooked, said second connecting rod pivoting on the hooking portion according to a third axis.

Said locking mechanism is configured to lock the first body against the second body upon pivoting of the first connecting rod when the second hinge axis between the two connecting rods overpasses a point of alignment between the three hinge axes consisting of the first axis, the second axis and the third axis and reaches a stable stop position.

The present disclosure also relates to an assembly including a mechanical coupling system according to the present disclosure, and a gripping device comprising at least one pneumatic actuator intended to be fluidly coupled to at least one compressed air source by said at least one channel.

According to an embodiment of said assembly, the gripping device is configured to grasp a stack of flat products bearing on a surface, including:
a first lower scrapper wing and a second lower scrapper wing, directed towards one another, configured to switch from a spaced position, on either side of the stack to be grasped into a close position for which said grasping wings slip under said stack bearing on the surface, as well as a first double-acting pneumatic cylinder, connected by a first channel and a second channel of said at least one channel, independent of one another, for the control of the first cylinder in both directions,
a first lateral stop and a second lateral stop, movable, configured to switch from a spaced position on either side of the stack to be grasped into a close position for which said lateral stops bear against two opposite sidewalls of the stack, as well as a second pneumatic cylinder connected by a third channel and a fourth channel of said at least one channel for the control of the second cylinder in both directions,
a movable upper stop, configured to switch from a raised position at a distance from an upper surface of the stack into a lowered position, for which the stack is held, at the bottom by the two grasping wings, and at the top by the upper stop, and a third pneumatic cylinder, connected by a fifth channel and a sixth channel of said at least one channel for the control of the third cylinder in both directions.

According to an embodiment of said assembly, said pneumatic actuator, in particular the third cylinder, is said cylinder integrated into the coupling system whose cylinder chamber is formed in a cavity of the second body, said fifth channel and the sixth channel respectively formed by said deployment control channel and said retraction control channel.

The present disclosure also relates to a robotic system, comprising an assembly according to the present disclosure, and a robotic arm secured to the first coupling portion of said mechanical coupling system.

The present disclosure also relates to a method for manufacturing a mechanical coupling system according to the present disclosure, or an assembly according to the present disclosure, wherein the first body, including the first channel portion, and/or the second body, including the second channel portion, are obtained by additive manufacturing.

The present disclosure also relates to the use of said coupling system according to the present disclosure, or of said assembly according to the present disclosure, or of the robotic system according to the present disclosure, in the food industry, said second body secured to a gripping device, for gripping food products such as in particular dairy products, meat products.

### BRIEF DESCRIPTION OF THE DRAWINGS

Other features, details and advantages will appear upon reading the detailed description hereinafter, and on analysis of the appended drawings, wherein:

FIG. 1 is a perspective view of an assembly comprising a coupling system comprising a first coupling portion, and a second coupling portion, in a mechanical locking position for which a first body and a second body are rigidly secured together, the second body belonging to the second coupling portion being secured to a gripping system comprising:
a first scrapper wing, and a second scrapper wing, configured to slip under an object to be grasped, such as a stack of flat products, actuated so as to get close to one another and to be spaced apart from one another by the action of a first double-acting pneumatic cylinder (flexible lines not illustrated),
a first lateral stop, and a second lateral stop configured to come into contact with two sidewalls of the stack, actuated so as to get close to one another and to be spaced apart from one another by the action of a second double-acting pneumatic cylinder (flexible lines not illustrated),
a movable upper stop, vertically actuated so as to descend or to rise by a third double-acting pneumatic cylinder, integrated into the second body of the mechanical coupling system.

FIG. 2 is a top view of the assembly according to FIG. 1.

FIG. 3 is a side view of the assembly:
the grasping scrapper wings, in the spaced position,
the lateral stops, in the spaced position,
the upper stop in a position raised by retraction of the third cylinder.

FIG. 4 is a view of FIG. 3, the grasping wings and the lateral stops in the close positions, and the upper stop in the lowered position.

FIG. 5 is a sectional view, according to a vertical plane, illustrating a deployment control channel extending from an inlet of the first body, and up to a cylinder chamber formed in the mass of the second body, on one side of a piston, the channel configured to ensure pressurisation of the cylinder to ensure movement of the piston in a direction of deployment of a rod secured to the piston, as well as a retraction control channel, extending from another inlet of the first body, and up to said cylinder chamber, on a second side of the piston, to ensure movement of the piston in the direction of retraction of the rod.

FIG. 6 is a sectional view according to a plane distinct from that of FIG. 5, illustrating two channels, each channel extending from an inlet of the first body, and up to an outlet of the second body, the inlets and outlets including fittings for the connection of flexible hoses, each channel comprising a first channel portion extending in the first body, fluidly extending by a second channel portion.

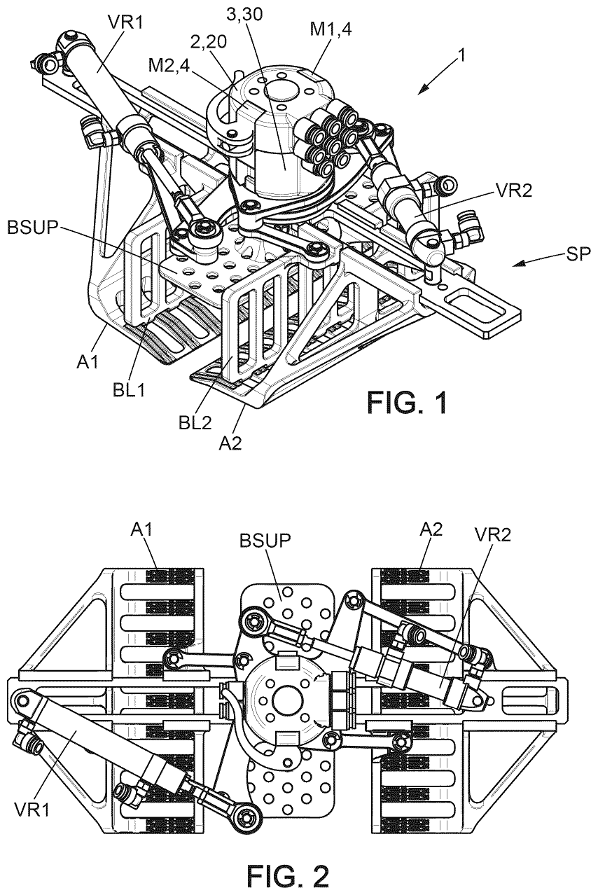

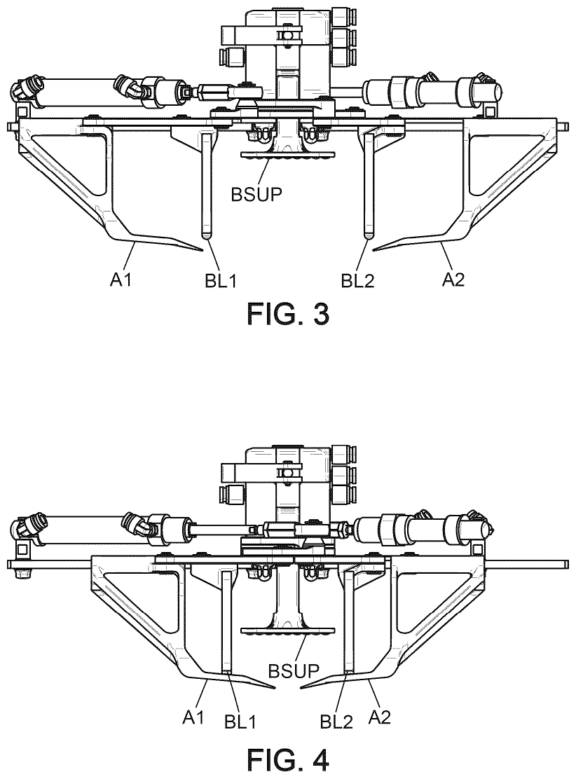

FIG. 7 is a side view of the coupling system, illustrating six inlets of the first body respectively belonging to:
a first channel and a second channel configured to control the first pneumatic cylinder respectively in the direction of retraction and in the direction of deployment,
a third channel and a fourth channel configured to control the second pneumatic cylinder respectively in the direction of retraction and in the direction of deployment,
a fifth cylinder and a sixth pneumatic cylinder to control the third pneumatic cylinder in the direction of retraction and in the direction of deployment, the view illustrating two outlets of the second body belonging to the third and fourth channels.

FIG. 8 is a side view, diametrically opposite to that one of FIG. 7, illustrating two outlets of the second body respectively belonging to the first and second channels.

FIG. 9A is a perspective view of another embodiment of the mechanical coupling system comprising two toggle mechanisms, diametrically opposite to one another to ensure locking of the first body against the second body, bringing the seals into contact at the inner ducts of the two bodies.

FIG. 9B is a sectional view according to a first plane passing through an axis of the coupling system.

FIG. 9C is a sectional view according to a second plane perpendicular to the first plane.

### DESCRIPTION OF THE EMBODIMENTS

Reference is now made to FIG. 1.

A mechanical coupling system 1 is provided comprising:
a first coupling portion 2, comprising a first body 20 configured to be handled by a manoeuvring system, such as a robotic arm,
a second coupling portion 3, comprising a second body 30 configured to secure a gripping device.

The coupling system also comprises a locking system 4 configured to switch from a locking position for which the first body 20 and the second body 30 are locked to one another, in particular against one another, and into an unlocking position enabling the separation of the first coupling portion 2 and of the second coupling portion 3.

In particular it may consist of a locking system, including a clamping mechanism comprising a first jaw M1 and a second jaw M2 secured to the first body, the jaws configured to clasp the second body 30 in a close position of the jaws M1, M2, and to enable uncoupling in a spaced position of the jaws M1, M2 or vice versa.

The mechanism may comprise a quick system comprising an axis linking the two jaws M1, M2, and on which one of the jaws slides, and an articulated clamping lever, comprising a cam portion configured to ensure clamping of the jaws by corner effect, and as illustrated in FIG. 1.

The clamping mechanism may also include (not illustrated) one or more clamping screw(s), crossing the first body 20, screwed into threaded bores of the second body 30, or vice versa (namely respectively that the threaded bores are formed on the first body), the screws including heads bearing on the first body (or respectively bearing on the second body). Preferably, the threaded bores are blind bores, and in particular in order to avoid the presence of interstice(s) into which moisture could enter and promote the presence of stagnant water favourable to the development of pathogens.

According to still another embodiment, illustrated in FIGS. 9A, 9B and 9C, said locking system may include one or more toggle mechanism(s). The or each toggle mechanism G includes a first connecting rod B1 pivotably hinged according to a first axis A1 to the first body 2, a second connecting rod B2 pivotably hinged on the first connecting rod B1 according to a second axis A2.

The hooking portion CT is then secured to the second body 30 on which a portion of the second connecting rod B2 can be removably hooked, said second connecting rod B2 then pivoting on the hooking portion CT according to a third axis A3.

Such a locking mechanism is configured to lock the first body 20 against the second 30 one upon pivoting of the first connecting rod when the second hinge axis A2 between the two connecting rods B1, B2 overpasses a point of alignment between the three hinge axes consisting of the first axis A1, the second axis A2 and the third axis A3, and said second axis A2 reaches a stable stop position. The positions of the hooking portion and of the levers may be inverted, namely the hooking portion may be secured to the first body, and the first lever hinged on the second body.

The locking system typically includes two toggle mechanisms, distributed diametrically opposite to one another on either side of the axis A.

Such a locking system is interesting in that it is quick to implement to lock (or unlock) the two bodies 20, 30 by moving the first connecting rod B1, which may have to this end a gripping portion, in a first direction up to the stable stop position upon locking, or in an opposite direction upon unlocking to enable clearance of the second connecting rod B2 from the hooking portion PC, and thus the separation of the two bodies 20, 30.

Remarkably, the coupling system includes a fluidic coupling system including from at least one fluid inlet E opening from the first body 20, and at least one channel Ca comprising:
a first inner channel portion PC1, extending in the mass of the first body 20 from said at least one fluid inlet E,
a second inner channel portion PC2, extending in the mass of the second body 30,
and wherein, in said locking position, the second channel portion PC2 extends, according to the length of the channel, fluidly in line with the first channel portion PC1. A sealing means ED ensures fluid tightness at the level of a junction area between the first channel portion PC1 and the second channel portion PC2.

The sealing means ED may typically comprise an O-ring gasket, secured to the first body or to the second body, pinched between the first body 20 and the second body 30, to ensure a tight connection at the junction between the first channel portion 20 and the second channel portion 30.

Said fluid inlet E is typically fluidly associated with a flexible hose of the robotic arm.

The number of channels Ca typically depends on the number of pneumatic actuators to be supplied on the gripping device and also depends on the nature of the pneumatic actuator namely in particular whether it consists of a single-acting actuator, requiring only one fluid supply, or of a double-acting actuator, requiring two independent supplies.

The number of channels may be one channel, or several channels, such as six channels according to the illustrated example which requires control of three double-acting actuators.

In any case, the fluidic coupling system substantially facilitates the operations of separation between the first portion secured to a robotic arm and the second portion of the coupling system, secured to the gripping device and more generally in that it is no longer necessary to uncouple the flexible hose(s) which always remain connected to the inlet E or the inlets E. The operations of mounting (and dismounting) the gripping device with respect to the robotic arm are substantially simplified.

According to one embodiment, said at least one channel Ca, in particular at least the first channel portion PC1 and/or the second channel portion PC2 has a curvilinear path. In particular, said curvilinear path extends according to the three dimensions of the space, said path not being contained in a plane.

In particular, the channel according to this embodiment does not results from a drilled bore, rectilinear by nature, or the combination of several drilled bores intersecting so as to ensure a change in direction, and which results in sharp edges at the level of the direction change area, difficult to clean, and promoting the development of pathogens.

In addition, the combination of two drilled bores may require plugging an orifice by a plug typically screwed into a thread of said orifice, resulting in the presence of a dead arm promoting the stagnation of moisture and thus the development of pathogens.

Thus, and in this manner, the channel Ca comprising the first channel portion PC1 and the second channel portion PC2 has no auxiliary channel, extending laterally from the first channel portion PC1 or from the second channel portion PC2, the auxiliary channel forming a non-through dead arm including an end closed by a plug, opposite to an end opening into the first channel portion or the second channel portion.

In other words, the inner channels of the mechanical coupling system communicate outside only at the level of the fluid inlet(s) E connected to one or more compressed air source(s), and possibly at the level of the fluid outlet(s) connected to the pneumatic actuators. The inner channels do not include an orifice communicating with the outside of the first body and second body that is sealed by a plug typically screwed into a thread, and as they are typically encountered in the field of coupling systems in the field of robotic systems for non-food related applications, where the inner channels result from several drilled bores intersecting so as to ensure a change in direction and in particular according to a prior art not compatible with the requirements of cleanability in the food industry.

A curvilinear path of said at least one channel Ca may be obtained typically by additive manufacturing, typically by 3D printing.

In general, the coupling system, including the first body 20 and the second body 30 may be made of a synthetic material selected amongst:
polyactic acid (abbreviated as PLA in English),
polypropylene (PP),
poly (ethylene terephthalate), abbreviated as PET in English,
polyamide, in particular Polylauramide (PA12).

These materials are compatible with an additive manufacturing, typically by 3D printing. Moreover, the material is compatible with food contact, in particular within the meaning of the regulation (EC) No. 1935/2004 of Oct. 27, 2004 and according to the FDA Food and Drug Administration.

According to one embodiment, the second channel portion PC2 extends at the end of the inlet of the channel up to a fluid outlet S opening from the second body 30. The outlet S is typically associated with a fitting Ra for a flexible hose, typically connecting the outlet to a pneumatic actuator or cylinder of the gripping device.

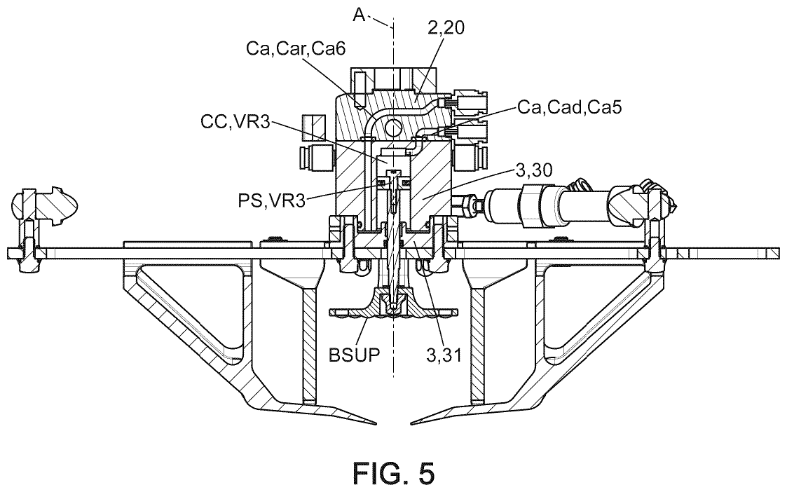

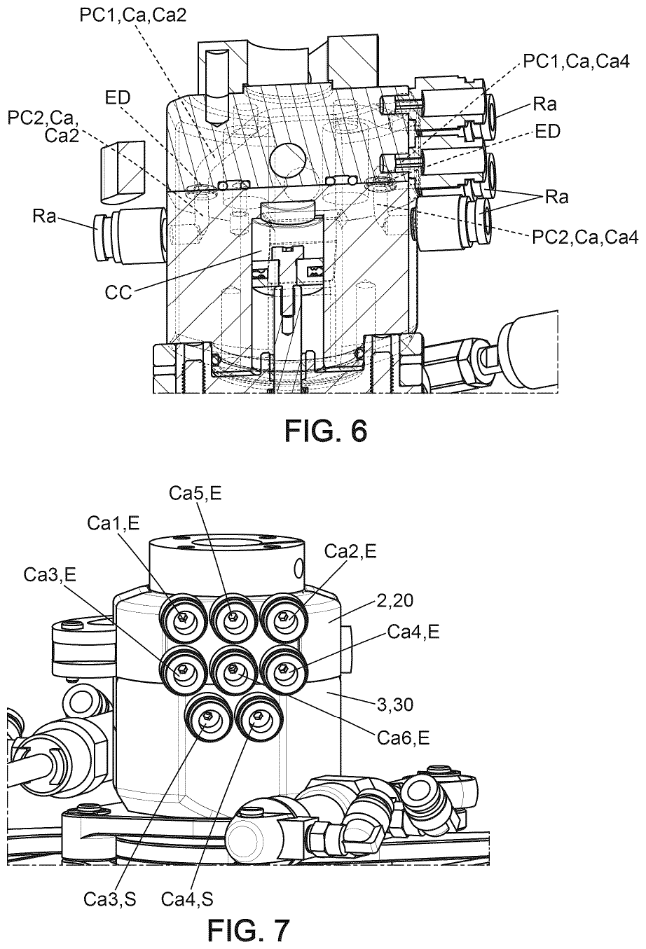

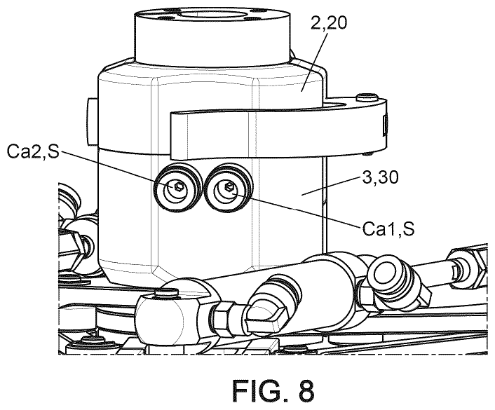

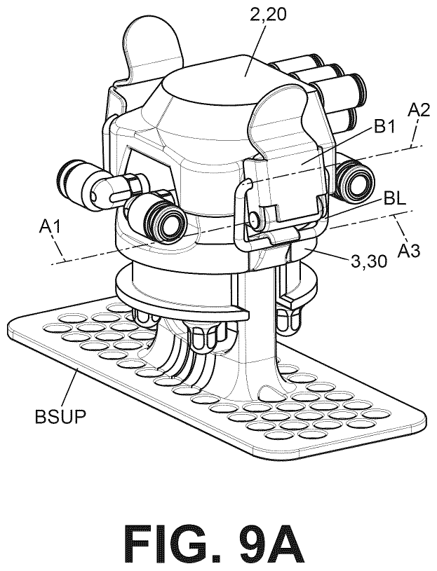

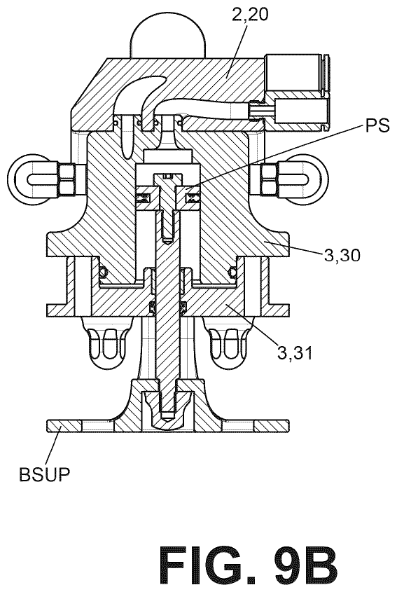

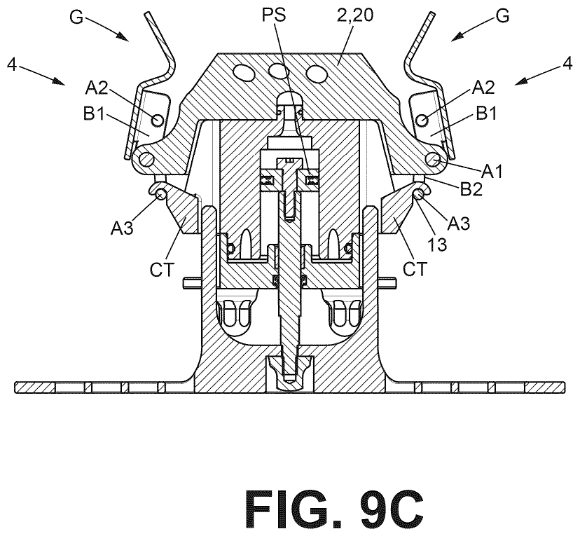

Nonetheless, the channel does not necessarily open from the second body through an outlet, for example when the second coupling portion 3 includes a pneumatic actuator integrated into the second body 30, and in particular as illustrated according to a possible embodiment in FIG. 5.

Thus, the second channel portion PC2 of said at least one channel may extend up to a cylinder chamber CC of a cylinder integrated into the mechanical coupling system, said cylinder chamber being obtained in the mass of said second body 20, typically obtained by additive manufacturing. Thus, the second body 20 may comprise an integrated cylinder, in particular as illustrated in the figures, or several integrated cylinders, each of the cylinders including a cylinder chamber being obtained in the mass of said second body 20, typically obtained by additive manufacturing.

The mechanical coupling system then comprises a piston PS (and possibly several pistons), internal to said cylinder chamber, belonging to the cylinder, configured to be constrained to move by a compressed fluid source supplied from said inlet E via said channel Ca.

Said integrated cylinder may be a double-acting cylinder, the piston PS dividing said cylinder chamber into a first chamber and a second chamber, said at least one channel including:
a deployment control channel Cad connected to the first chamber, comprising the first channel portion PC1 and the second channel portion PC2 opening into the first chamber, on a first side of the piston PS, configured to be connected to a compressed fluid source to slidably actuate the piston in a first direction (in deployment),
a retraction control channel Car connected to the second chamber, comprising the first channel portion PC1 and the second channel portion PC2 opening into the second chamber, on a second side of the piston, configured to be connected to a compressed fluid source to slidably actuate the piston in a second direction (in retraction).

According to one embodiment, the integrated cylinder may be directed substantially coaxially with the axis of the mechanical coupling system including the first body and the second body. In comparison with a design wherein the coupling system and the pneumatic cylinder (not integrated) would be simply juxtaposed, having an integrated design of the cylinder allows reducing the compactness according to the axis A of the mechanical coupling system. Still another advantage is that cleanability is substantially improved.

In general, the second coupling portion 3 may comprise the second body 30 inside which the cavity cylinder chamber is obtained, as well as a cover portion 31, crossed by a cylinder rod secured to the piston PS. Said cover portion 31 is removably fastened to the second body 30 to enable the insertion or the extraction of the piston PS. The cover portion comprises an opening for the passage of the rod of the cylinder, as well as a sealing system ensuring tightness between the cover portion 31 and the rod of the cylinder.

According to a second aspect, the present disclosure relates to an assembly including a mechanical coupling system 1 according to the present disclosure, and a gripping device SP comprising at least one pneumatic actuator intended to be fluidly coupled to at least one compressed air source through said at least one channel Ca.

In the case where said at least one actuator is external to said mechanical coupling system, namely the cylinder is not integrated, at least one flexible hose connects said pneumatic actuator to a fitting Ra of an outlet S of the second body 30.

In the case where the actuator is integrated, as explained before, the channel Ca directly connects the cylinder chamber CC formed by a cavity in the second body 30.

According to one embodiment, the gripping device is configured to grasp flat products bearing on a surface, said gripping device including:
a first lower grasping scrapper wing A1 and a second lower grasping scrapper wing A2, directed towards one another, configured to switch from a spaced position, on either side of the stack to be grasped into a close position for which said grasping wings A1, A2 slip under said stack bearing on the surface, typically while scrapping the surface, as well as a first double-acting pneumatic cylinder VR1, connected through a first channel Ca1 and a second channel Ca2 of said at least one channel, independent of each other, for the control of the first cylinder in both directions,
a first lateral stop BL1 and a second lateral stop BL2, movable, configured to switch from a position spaced apart on either side of the stack to be grasped into a close position for which said lateral stops BL1, BL2 bear against two opposite sidewalls of the stack, as well as a second pneumatic cylinder VR2 connected through a third channel Ca3 and a fourth channel Ca4 of said at least one channel Ca for the control of the second cylinder VR2 in both directions,
a movable upper stop BSUP, configured to switch from a raised position at a distance from an upper surface of the stack into a lowered position, for which the stack is held, at the bottom by the two grasping wings A1, A2, and at the top by the upper stop BSUP, and a third pneumatic cylinder VR3, connected through a fifth channel Ca5 and a sixth channel Ca6 of said at least one channel Ca for the control of the third cylinder VR3 in both directions.

Advantageously, one could notice that, in particular, the third cylinder VR3 may consist of said cylinder integrated into the coupling system whose cylinder chamber CC is formed in a cavity of the second body 30, said fifth channel Ca5 and the sixth channel Ca6 respectively formed by said deployment control channel Cad and said retraction control channel Car. In such a case, the stop BSUP is secured to the end of the rod secured to the piston PS internal to the second body 30.

Such a gripping device allows grasping a stack of flat products, for example cheese, meat products, or others; according to a grasping sequence comprising:
positioning the gripping device, the two grasping wings A1, A2 in the spaced position, on either side of a stack to be grasped bearing on a support surface,
bringing the first grasping wing A1 and the second grasping wing A2 close to one another, while scrapping the support surface, until slipping of the first wing A1 and of the second wing A2 under the stack, by control of the first pneumatic cylinder VR1,
bringing the first lateral stop BL1 and the second lateral stop BL2 close to one another, respectively coming into contact with two opposite sidewalls of the stack, in particular in order to ensure centring of the different superposed products forming the stack, by control of the second pneumatic cylinder VR2,
lowering the upper stop through a control of the third cylinder, until gripping the stack clasped between, on the one hand, the upper stop BSUP by bearing at the top on the upper product of the stack and, on the other hand, the two grasping wings A1 and A2, by bearing on the lower product of the stack.

Once grasped and held, the stack can be moved by the robotic arm, and until release thereof, for example into a packaging, such as a thermoformed tray, without any risk of deterioration of the stack.

The present disclosure also relates to a robotic system, comprising an assembly according to the present disclosure, and a robotic arm secured to the first coupling portion of said mechanical coupling system. In particular, the robotic arm includes one or more flexible line(s) connected to one or more fitting(s) Ra associated with the fluid E.

When the gripping device is separated from the robotic arm, by unlocking the locking mechanism 4 enabling the separation of the removable first coupling portion 2, and the second coupling portion 3, the fluidic coupling system allows fluidly and automatically uncoupling the gripping device from the robotic arm, in particular the flexible lines connected to the fittings Ra of the inlets E, as well as the flexible lines connected to the fittings of the outlets S which could remain connected in place.

### INDUSTRIAL APPLICATION

The present disclosure also relates to a method for manufacturing a mechanical coupling system according to the present disclosure, or an assembly according to the present disclosure wherein the first body, including the first channel portion PC1 and/or the second channel portion PC2, is obtained by additive manufacturing.

The present disclosure also relates to the use of said coupling system according to the present disclosure or of said assembly according to the present disclosure, or of the robotic system according to the present disclosure, in the food industry, said second body 30 secured to a gripping device SP, for gripping food products.

The food products may consist of dairy products (cheese), meat products, or others.

As far as possible, the outer surface of the first body 2 and that of the second body 3 are free of interstices promoting water retention which is favourable to the development of pathogens, or sharp edges, which affect cleanability.

On the contrary, the external surfaces are preferably smooth, non-planar, promoting water flow: the external surface of the device is free of cavities or any other surface promoting water accumulation and the development of pathogens. Preferably, the roughness Ra of the external surfaces is less than or equal to 6 micrometres. Such a coupling system can be easily cleaned by aspersion of water, and possibly a cleaning solution, without any risk of water accumulating on the external surfaces of the coupling system, or in cavities of the coupling system, and do not promote the development of pathogens.

### LIST OF THE REFERENCE SIGNS

1: Mechanical coupling system,
2. First coupling portion,
20. First body,
3. Second coupling portion,
30. Second body,
4. Locking system,
G toggle mechanism,
B1, B2. First connecting rod and second connecting rod (toggle lever)
PC. Hooking portion
A1. First hinge axis (of the first connecting rod on the first body)
A2. Second hinge axis (between the first connecting rod and the second connecting rod),
A3. Third hinge axis between the second connecting rod and the hooking portion,
A. Axis of the coupling system,
E. Fluid inlet(s),
ED. Sealing means,
S. Fluid outlet(s),
Ca. At least one channel,
Ca1, Ca2, Ca3, Ca4, Ca5, Ca6. Respectively first, second, third, fourth, fifth and sixth channel,
Cad. Deployment control channel,
Car. Retraction control channel,
CC. Cylinder chamber (integrated into the second body)
PS. Piston,
Ra. Connector,
M1, M2. First and second clamp,
SP. Gripping system,
A1, A2. First scrapper grasping wing and second scrapper grasping wing,
BL1, BL2. First lateral stop, and second lateral stop,
BSUP. Upper stop,
VR1, VR2, VR3. First, second and third pneumatic cylinder.

1. A mechanical coupling system comprising:
a first coupling portion comprising a first body configured to be handled by a manoeuvring system, such as a robotic arm,
a second coupling portion, comprising a second body configured to secure a gripping device
a locking system configured to switch from a locking position for which the first body and the second body are locked together, an into an unlocking position enabling the separation of the first coupling portion and of the second coupling portion and wherein the coupling system is made of one or more material(s) compatible with food contact, and that it includes a fluidic coupling system including from at least one fluid inlet opening from the first body, and at least one channel comprising:
an inner first channel portion, extending in the mass of the first body from said at least one fluid inlet,
an inner second channel portion, extending in the mass of the second body, and wherein, in said locking position, the second channel portion extends, according to the length of the channel, fluidly in line with the first channel portion, a sealing means ensuring fluid tightness at the level of a junction area between the first channel portion and the second channel portion.

2. The mechanical coupling system, according to claim 1, wherein said at least one channel, in particular at least the first channel portion and/or the second channel portion has a curvilinear path.

3. The mechanical coupling system, according to claim 2, wherein said curvilinear path extends according to the three dimensions of the space, said path not being contained in a plane.

4. The mechanical coupling system, according to claim 1, wherein the channel comprising the first channel portion and the second channel portion has no auxiliary channel, extending laterally from the first channel portion or from the second channel portion, the auxiliary channel forming a non-through dead arm including an end closed by a plug, opposite to an end opening into the first channel portion or the second channel portion.

5. The mechanical coupling system according to claim 1, wherein the second channel portion extends at the opposite end of the inlet of the channel up to a fluid outlet opening from the second body.

6. The mechanical coupling system, according to claim 1, wherein the first coupling portion comprises a fitting connected to the fluid inlet configured for the fluidic connection of a flexible hose, and, where appropriate, when the system is according to claim 5, a fitting connected to the fluid outlet configured for the fluidic connection of a flexible hose, extending in particular up to a pneumatic cylinder.

7. The mechanical coupling system, according to claim 1, wherein the second channel portion of sad at least one channel extending up to a cylinder chamber of at least one cylinder integrated into the mechanical coupling system, said cylinder chamber being obtained in the mass of said second body, said mechanical coupling system comprising a piston, internal to said cylinder chamber, configured to be moved by a compressed fluid source supplied from said inlet via said channel.

8. The mechanical coupling system according to claim 7, wherein said integrated cylinder is a double-acting cylinder, the piston dividing said cylinder chamber into a first chamber and a second chamber, said at least one channel including:
a deployment control channel connected to the first chamber, comprising the first channel portion and the second channel portion opening into the first chamber, on a first side of the piston, configured to be connected to a compressed fluid source to slidably actuate the piston in a first direction,
a retraction control channel connected to the second chamber, comprising the first channel portion and the second channel portion opening into the second chamber, on a second side of the piston, configured to be connected to a compressed fluid source to slidably actuate the piston in a second direction.

9. The coupling system according to claim 7, wherein the second coupling portion comprising a second body inside which the cavity-like cylinder chamber is obtained, as well as a cover portion, crossed by a rod secured to the piston, said cover portion removably fastened to the second body to enable the insertion or the extraction of the piston.

10. The mechanical coupling system according to claim 1, wherein the first body and the second body are made of one or more synthetic material(s) selected among:
polyactic acid,
polypropylene,
poly,
polyamide, in particular polylauramide.

11. The coupling system according to claim 1, wherein the external surfaces of said system, including of the first body and of the second body, are smooth; non-planar, promoting the water flow, devoid of cavities promoting the accumulation of water and microbial development, the external surfaces having a roughness Ra lower than or equal to 6 micrometres.

12. The mechanical coupling system according to claim 1, wherein said locking system includes:
a clamping system comprising a first jaw and a second jaw secured to the first body configured to clasp the second body in a close position of the jaws, and to enable uncoupling in a spaced position of the jaws or alternatively,
a clamping mechanism including one or more clamping screw(s), crossing the first body, screwing threaded bores of the second body, or vice versa, preferably blind bores.

13. The mechanical coupling system according to claim 1, wherein said locking system includes one or more toggle mechanism(s), the or each toggle mechanism including a first connecting rod pivotably hinged according to a first axis to the first body, a second connecting rod pivotably hinged on the first connecting rod according to a second axis, and a hooking portion secured to the second body, on which a portion of the second connecting rod can be pivotably hooked, said second connecting rod pivoting on the hooking portion according to a third axis and wherein said locking mechanism is configured to lock the first body against the second one upon pivoting of the first connecting rod when the second hinge axis between the two connecting rods overpasses a point of alignment between the three hinge axes consisting of the first axis, the second axis and the third axis and reaches a stable stop position.

14. An assembly including a mechanical coupling system according to claim 1, and a gripping device comprising at least one pneumatic actuator intended to be fluidly coupled to at least one compressed air source by said at least one channel.

15. The assembly according to claim 14, wherein the gripping device is configured to grasp a stack of flat products bearing on a surface, including:
a first lower scrapper wing and a second lower scrapper wing, directed towards one another, configured to switch from a spaced position, on either side of the stack to be grasped into a close position for which said grasping wings slip under said stack bearing on the surface, as well as a first double-acting pneumatic cylinder, connected by a first channel and a second channel of said at least one channel, independent of one another, for the control of the first cylinder in both directions,
a first lateral stop and a second lateral stop, movable, configured to switch from a spaced position on either side of the stack to be grasped into a close position for which said lateral stops bear against two opposite sidewalls of the stack, as well as a second pneumatic cylinder connected by a third channel and a fourth channel of said at least one channel for the control of the second cylinder in both directions,
a movable upper stop, configured to switch from a raised position at a distance from an upper surface of the stack into a lowered position, for which the stack is held, at the bottom by the two grasping wings, and at the top by the upper stop, and a third pneumatic cylinder, connected by a fifth channel and a sixth channel of said at least one channel for the control of the third cylinder in both directions.

16. The assembly according to one claim 15, wherein said pneumatic actuator, in particular the third cylinder, is said cylinder integrated into the coupling system whose cylinder chamber is formed in a cavity of the second body, said fifth channel and the sixth channel respectively formed by said deployment control channel and said retraction control channel.

17. A robotic system, comprising an assembly according to claim 14, and a robotic arm secured to the first coupling portion of said mechanical coupling system.

18. A method for manufacturing a mechanical coupling system according to claim, wherein the first body, including the first channel portion, and/or the second body, including the second channel portion, are obtained by additive manufacturing.

19. A method of use of said coupling system according to claim 1, in the food industry, said second body secured to a gripping device, for gripping food products such as in particular dairy products, meat products.
